(19) United States
(12) Patent Application Publication
(10) Pub. No.: US 2006/0249614 A1
(43) Pub. Date: Nov. 9, 2006

(54) Belt retractor with reversible belt tensioner drive

(75) Inventor: Wolfgang Holbein, Alfdorf (DE)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: TRW Automotive GmbH

(21) Appl. No.: 11/415,650

(22) Filed: May 2, 2006

(30) Foreign Application Priority Data
May 9, 2005 (DE) 10 2005 021 283.2

(51) Int. Cl. B60R 22/46; B60R 22/36

(52) U.S. Cl. 242/374; 242/379.1; 242/382

(57) ABSTRACT

A belt retractor (10) for a motor vehicle includes a retractor housing (12) and a belt spool (14) for a safety belt. The belt spool (14) is rotatably mounted in the retractor housing (12) and has a first side and an opposed locking side. The belt retractor (10) further includes a blocking mechanism acting on the locking side of the belt spool (14) and a reversible belt tensioner drive which can drive the belt spool (14) in a winding direction for winding the safety belt. The reversible belt tensioner drive is coupled to the locking side of the belt spool (14).

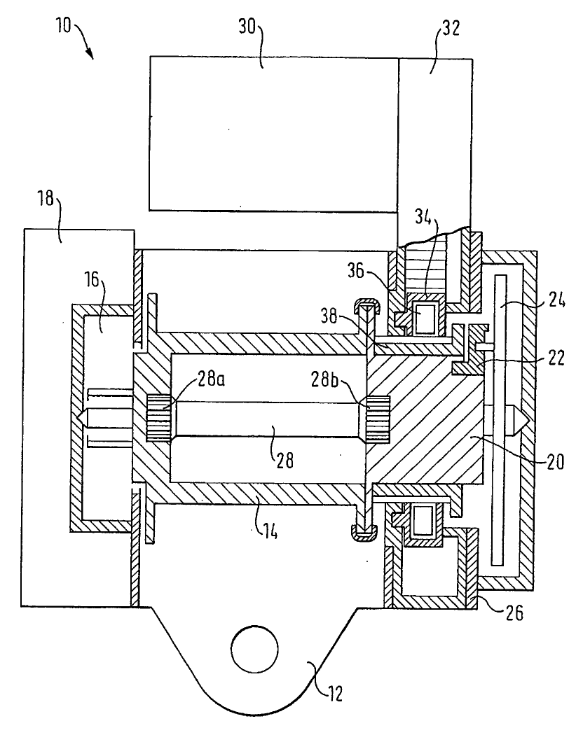

### TECHNICAL FIELD

The invention relates to a belt retractor for a motor vehicle.

### BACKGROUND OF THE INVENTION

A reversible belt tensioner drive typically has an electric motor which can drive the belt spool in a hazardous situation so that the safety belt is wound up. In this way, on the one hand the so-called belt slack can already be eliminated before an accident occurs. On the other hand, if, for example, the vehicle occupant is in a bent forward position, he can be pulled back into an upright position. As soon as the hazardous situation is over, the belt tensioner drive releases the belt spool again such that the belt retractor returns to its conventional mode of operation.

If an accident occurs after the activation of the belt tensioner drive, the vehicle occupant withdraws safety belt from the belt spool. On the one hand, this withdrawal is caused because the belt spool must be rotated by a particular amount in the unwinding direction of the safety belt until the blocking mechanism responds. The rotation of the belt spool in the unwinding direction may, however, also be explained by the presence of a force-limiting arrangement which makes possible a controlled return rotation of the belt spool when particularly high forces are acting in the safety belt.

German Utility Model DE 203 15 870 U1 shows a belt retractor comprising a retractor housing, a belt spool for a safety belt, which is rotatably mounted in the retractor housing and has a first side and an opposite locking side, a blocking mechanism acting on the locking side of the belt spool, and a reversible belt tensioner drive which can drive the belt spool in a winding direction for winding the safety belt. In order that the blocking or braking moments of the reversible belt tensioner drive do not add on the force level in an uncontrolled manner during the force limitation, and in order to avoid possible damage to the reversible belt tensioner drive, a torque limiter in the form of a slip clutch is provided between the belt tensioner drive and the belt spool. Depending on whether the reversible belt tensioner drive a) is not coupled, b) is coupled but not provided with current, or c) is coupled and provided with current, the reversible belt tensioner drive would otherwise in fact a) not, b) moderately, or c) intensively counteract the force limitation, respectively.

If a belt retractor with a reversible belt tensioner drive is to be additionally equipped with a pyrotechnic tensioner to perform an emergency tensioning, a further problem arises. If the pyrotechnic tensioner were to be activated, the reversible belt tensioner drive would basically have to be deactivated in order to ensure a reliable emergency tensioning. A combination of a reversible belt tensioner drive with a pyrotechnic tensioner consequently requires a high expenditure for development.

It is an object of the invention to provide a belt retractor with a reversible belt tensioner drive which can do without particular compensation measures to avoid the above-mentioned problems.

### BRIEF SUMMARY OF THE INVENTION

According to the invention, a belt retractor for a motor vehicle comprises a retractor housing and a belt spool for a safety belt. The belt spool is rotatably mounted in the retractor housing and has a first side and an opposed locking side. The belt retractor further comprises a blocking mechanism acting on the locking side of the belt spool and a reversible belt tensioner drive which can drive the belt spool in a winding direction for winding the safety belt. The reversible belt tensioner drive is coupled to the locking side of the belt spool. The invention proceeds from the finding that the problems initially mentioned are caused by the typical connection of the functional units in conventional belt retractors. Hitherto, the reversible belt tensioner drive was coupled to the side of the belt spool opposed to the locking side, i.e. it was coupled to the side on which also the driving spring and possibly a pyrotechnic tensioner engage. By contrast, in the belt retractor according to the invention, the reversible belt tensioner drive drives the locking side of the belt spool. The belt retractor according to the invention has the advantages that the reversible belt tensioner drive is independent of the driving spring and, if present, of the pyrotechnic tensioner, such that torque or overload limitations are not necessary. The problem that the state of the reversible belt tensioner drive influences the force limitation of the belt retractor is basically avoided by the design according to the invention. Standard components can be used for the various functional units of the belt retractor such as blocking mechanism, pyrotechnic tensioner and force-limiting arrangement. The separation of the reversible belt tensioner drive from the side of the belt spool opposed to the locking side basically makes it possible to use a reversible belt tensioner drive in various belt retractor designs. In addition, the development of various electronic control units for the belt retractor can be dispensed with, because the connections to the motor and to the retractor housing are identical for the various types of the belt retractor.

According to the preferred embodiment of the invention, the belt retractor further comprises a force-limiting arrangement. The reversible belt tensioner drive is arranged between the locking side of the belt spool and the force-limiting arrangement. The arrangement of the reversible belt tensioner drive is not necessarily to be understood in a positional sense, but rather in a functional sense.

The force-limiting arrangement preferably includes a torsion rod having two ends, one end is supported on the first side of the belt spool and the other end is supported in a component of the belt retractor which is fixedly held with the housing when the blocking mechanism is activated.

In the preferred embodiment, the blocking mechanism is vehicle-sensitive and/or belt band-sensitive and has a catch carrier coupled non-rotatably to the belt spool. The catch carrier has a blocking catch which is able to be guided into locking teeth which are fixedly held with the vehicle.

An advantageous construction of the belt retractor according to the invention is provided in that the locking teeth are attached to a component of the reversible belt tensioner drive which is fixedly held with the housing.

According to a particularly advantageous realization of the idea of the invention, the reversible belt tensioner drive has at least one coupling catch which is able to be guided into a toothed component which, in turn, is fixedly held with the housing when the blocking mechanism is activated.

The belt retractor according to the invention may further comprise a driving spring and/or a pyrotechnic tensioner which is/are coupled to the first side of the belt spool.

### BRIEF DESCRIPTION OF THE DRAWING

In the drawing, the single FIGURE shows diagrammatically a sectional view of a belt retractor according to the invention.

### DETAILED DESCRIPTION OF THE PREFERRED EMBODIMENT

The belt retractor 10 for a motor vehicle, as illustrated in the FIGURE, comprises a belt spool 14 which is rotatably mounted in a retractor housing 12. On the belt spool 14 a portion of a safety belt is wound. Belt band is wound by rotation of the belt spool 14 in a first direction (winding direction), and belt band is unwound by rotation of the belt spool 14 in a second direction (unwinding direction).

A driving spring 16, which pre-stresses the safety belt in the winding direction, engages on a first side of the belt spool 14. A pyrotechnic tensioner 18, by which an emergency tensioning can be carried out, is also arranged on the same side. The pyrotechnic tensioner 18 is coupled to the first side of the belt spool 14 and can immediately turn the belt spool 14 in the winding direction about a particular angle of rotation, if required.

On the locking side of the belt spool 14, opposed to the first side, the belt retractor has a blocking mechanism with a catch carrier 20 connected non-rotatably to the belt spool 14, a blocking catch 22, a coupling plate 24 and locking teeth 26 which are fixed to the vehicle. The blocking mechanism is activated in a vehicle- and/or belt band-sensitive manner and blocks a rotation of the belt spool 14 by guiding the locking catch 22 into the locking teeth 26.

The belt retractor 10 further comprises a force-limiting arrangement with a torsion rod 28. One end 28a of the torsion rod 28 is supported on the first side in the belt spool 14 and the other end 28b is supported in the catch carrier 20 on the locking side. When the blocking mechanism is activated, the catch carrier 20 is certainly prevented from rotating in the unwinding direction, but a rotation of the belt spool 14 in unwinding direction is possible, with a twisting of the torsion rod 28, when particularly high forces are acting in the safety belt.

The details of the above-mentioned functional units of the belt retractor 10 are known to the person skilled in the art and are of minor importance for the present invention, so they do not have to be entered into in further detail here.

The belt retractor 10 is equipped with a reversible belt tensioner drive which is composed of an electric motor 30, a gear 32, a coupling 34, coupling catches 36 and a toothed ring 38. The toothed ring 38 is placed non-rotatably onto the catch carrier 20, and the catch carrier 20, in turn, is connected non-rotatably with the belt spool 14. The remaining components of the reversible belt tensioner drive are fastened to the retractor housing 12, the housing of the gear 32 serving as carrier of the locking teeth 26 of the blocking mechanism. If required, the coupling catches 36 are driven into the toothed ring 38 so that the electric motor 30 can drive the belt spool 14.

It is particularly important that the toothed ring 38, through its connection with the catch carrier 20, represents a link between the reversible belt tensioner drive and the blocking mechanism. On activation of the blocking mechanism the locking catch 22 engages into the locking teeth 26 which transfer the introduced force via the gear housing to the retractor housing 12.

If, with the belt spool 14 blocked, a withdrawal of belt band occurs owing to particularly high forces in the safety belt, the level of force limitation is determined solely by the torsion rod 28, i.e. in particular independently of the operating state of the reversible belt tensioner drive. This is due to the fact that the reversible belt tensioner drive in the coupled state, with the electric motor 30 provided with current, can in fact engage on the toothed ring 38 via the coupling catches 36, but the toothed ring 38 passes on the driving forces via the locking teeth 26 without acting on the retractor housing 12, owing to the blocking of the catch carrier 20.

1. A belt retractor for a motor vehicle, the belt retractor comprising
a retractor housing,
a belt spool for a safety belt, the belt spool being rotatably mounted in the retractor housing and having a first side and an opposed locking side,
a blocking mechanism acting on the locking side of the belt spool, and
a reversible belt tensioner drive which can drive the belt spool in a winding direction for winding the safety belt, the reversible belt tensioner drive being coupled to the locking side of the belt spool.

2. The belt retractor according to claim 1, further comprising a force-limiting arrangement, the reversible belt tensioner drive being arranged between the locking side of the belt spool and the force-limiting arrangement.

3. The belt retractor according to claim 2, wherein the force-limiting arrangement includes a torsion rod having two ends, one end being supported on the first side of the belt spool and the other end being supported in a component of the belt retractor which is fixedly held with the housing when the blocking mechanism is activated.

4. The belt retractor according to claim 1, wherein the blocking mechanism is vehicle- and/or belt band-sensitive and has a catch carrier coupled non-rotatably to the belt spool, the catch carrier having a blocking catch which is able to be guided into locking teeth which are fixedly held with the housing.

5. The belt retractor according to claim 4, wherein the locking teeth are attached to a component of the reversible belt tensioner drive which is fixedly held with the housing.

6. The belt retractor according to claim 1, wherein the reversible belt tensioner drive has at least one coupling catch which is able to be guided into a toothed component which, in turn, is fixedly held with the housing when the blocking mechanism is activated.

7. The belt retractor according to claim 1, further comprising a driving spring coupled to the first side of the belt spool.

8. The belt retractor according to claim 1, further comprising a pyrotechnic tensioner coupled to the first side of the belt spool.
